(19) United States
(12) Patent Application Publication
(10) Pub. No.: US 2022/0067684 A1
(43) Pub. Date: Mar. 3, 2022

(54) POINT-OF-SALE TERMINAL TRANSFER

(71) Applicant: International Business Machines Corporation, Armonk, NY (US)

(72) Inventors: Igor S. Ramos, Round Rock, TX (US); Devon E. Mensching, Austin, TX (US); Angelo Danducci, II, Austin, TX (US); Kimberly J. Taft, Austin, TX (US)

(21) Appl. No.: 17/002,011

(22) Filed: Aug. 25, 2020

(51) Int. Cl. G06Q 20/20; G06F 3/0481

(52) U.S. Cl. CPC G06Q 20/20; G06F 3/04817

(57) ABSTRACT

An application on a computing device of a user is initiated. The application allows the user to complete a purchase via the computing device instead of a point-of-sale (POS) terminal. A set of preferences of the user is retrieved. A new interface of the POS terminal is generated on the computing device. The new interface is based on the retrieved set of preferences. The new interface includes one or more screens and icons that perform one or more POS terminal capabilities when selected by the user. The generated new interface is rendered on the computing device.

### BACKGROUND

The present invention relates generally to the field of point-of-sale terminal usage, and more particularly to providing for a transfer of a point-of-sale (POS) terminal to a computing device of a user and generating a remote POS terminal on said computing device.

Some retail operations such as grocery stores and gas stations are moving away from a full-service model to a self-service model. In the self-service model, a consumer is required to use a point-of-sale terminal to complete a transaction, including making a payment. The payment can be made in a variety of ways including cash, a credit card, and a payment service via a smart device such as a smartphone or a smartwatch. A POS terminal is presented in the native language of where it is located (e.g., in Finland, a POS terminal is presented in the Finnish language).

### SUMMARY OF THE INVENTION

Embodiments of the present invention include an approach for providing for a transfer of a point-of-sale terminal to a computing device of a user and generating a remote POS terminal on said computing device. In one embodiment, an application on a computing device of a user is initiated. The application allows the user to complete a purchase via the computing device instead of a point-of-sale (POS) terminal. A set of preferences of the user is retrieved. A new interface of the POS terminal is generated on the computing device. The new interface is based on the retrieved set of preferences. The new interface includes one or more screens and icons that perform one or more POS terminal capabilities when selected by the user. The generated new interface is rendered on the computing device.

### BRIEF DESCRIPTION OF THE DRAWINGS

FIG. 1 depicts a functional block diagram of a computing environment, in accordance with an embodiment of the present invention;

FIG. 2 depicts a flowchart of a program providing for a transfer of a point-of-sale terminal to a computing device of a user and generating a remote POS terminal on said computing device, in accordance with an embodiment of the present invention;

FIG. 3A is an exemplary example of a POS terminal that might be used in an English speaking country, in accordance with an embodiment of the present invention;

FIG. 3B is an exemplary example of a generated POS terminal translated on a computing device of a user, in accordance with an embodiment of the present invention;

FIG. 3C is a continuation of the exemplary example depicted in FIG. 3B, in accordance with an embodiment of the present invention; and

FIG. 4 depicts a block diagram of components of the computing environment of FIG. 1, in accordance with an embodiment of the present invention.

### DETAILED DESCRIPTION

Embodiments of the present invention recognize that using a point-of-sale (POS) terminal can be confusing. Where is the “ENTER” button? How do I get a receipt for my purchase? Further, accessibility issues can arise when a small display screen is used or a glare from the sun covers the screen. Further yet, difficulties can worsen when the language presented in the display is a second language for the user; for example, consider the scenario of a German speaking user attempting to use a POS terminal in Sweden, where the terminal presents information in the Swedish language.

Embodiments of the present invention recognize that there may be a method, computer program product, and computer system for providing for a transfer of a point-of-sale terminal to a computing device of a user and generating a user interface for a remote POS terminal on said computing device utilizing preferences of the user. In an embodiment, the method, computer program product, and computer system recognize the preferences of a user and transfers a POS terminal (i.e., displays the terminal) on a computing device of the user, thus creating a remote version of the POS terminal and rendering the remote POS terminal in the preferred language and format of the user. The transferred POS terminal rendered in a way familiar to the user allows the user to complete transactions quickly and confidently.

References in the specification to “one embodiment”, “an embodiment”, “an example embodiment”, etc., indicate that the embodiment described may include a particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The present invention will now be described in detail with reference to the Figures.

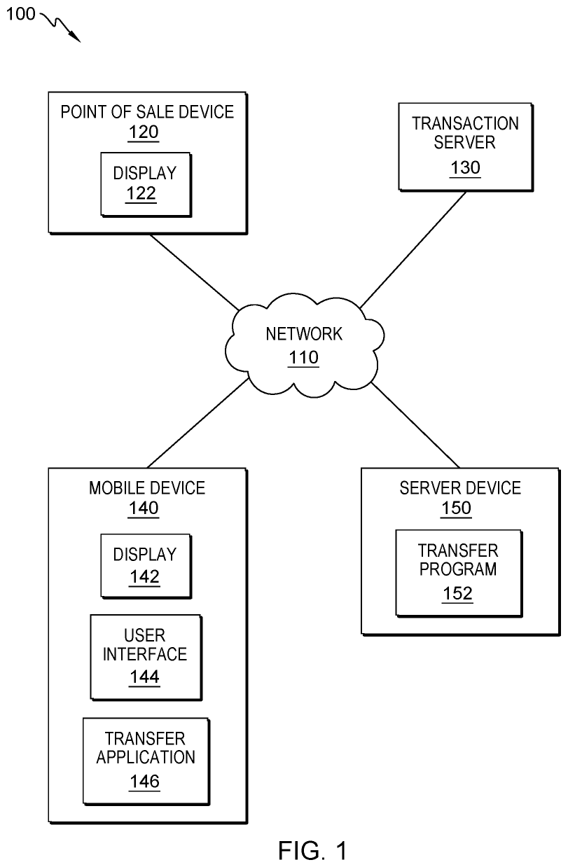

FIG. 1 is a functional block diagram illustrating a computing environment, generally designated 100, in accordance with one embodiment of the present invention. FIG. 1 provides only an illustration of one implementation and does not imply any limitations with regard to the systems and environments in which different embodiments may be implemented. Many modifications to the depicted embodiment may be made by those skilled in the art without departing from the scope of the invention as recited by the claims.

In an embodiment, computing environment 100 includes point-of-sale (POS) device 120, transaction server 130, mobile device 140, and server device 150, interconnected by network 110. In example embodiments, computing environment 100 includes other computing devices (not shown in FIG. 1) such as smartwatches, cell phones, additional smartphones, wearable technology, phablets, tablet computers, additional laptop computers, additional desktop computers, other computer servers or any other computer system known in the art, interconnected with POS device 120, transaction server 130, mobile device 140, and server device 150 over network 110

In embodiments of the present invention, POS device 120, transaction server 130, mobile device 140, and server device 150 are connected to network 110, which enables POS device 120, transaction server 130, mobile device 140, and server device 150 to access other computing devices and/or data not directly stored on POS device 120, transaction server 130, mobile device 140, and server device 150. Network 110 may be, for example, a short-range, low power wireless connection, a local area network (LAN), a telecommunications network, a wide area network (WAN) such as the Internet, or any combination of the four, and include wired, wireless, or fiber optic connections. In an embodiment, network 110 includes one or more wired and/or wireless networks that are capable of receiving and transmitting data, voice, and/or video signals, including multimedia signals that include voice, data, and video information. In general, network 110 is any combination of connections and protocols that will support communications between POS device 120, transaction server 130, mobile device 140, and server device 150, and any other computing devices (not shown in FIG. 1) connected to network 110, in accordance with embodiments of the present invention. In an embodiment, data received by another computing device (not shown in FIG. 1) in computing environment 100 is communicated to POS device 120, transaction server 130, mobile device 140, and server device 150 via network 110.

In an embodiment, POS device 120 is a computer-based system that allows businesses to capture sales data and other customer transactions. POS device 120 may combine computers or POS kiosks with cash registers, bar code readers, scanners, and magnetic stripe readers. POS device 120 may be a standalone machine that processes store transactions and later delivers transaction information to a central computer, or POS device 120 may be connected to a central computer for real time credit and inventory checks. In an embodiment, the software systems (not shown in FIG. 1) for POS device 120 are an important, frontline piece of an information system for a company. Information from POS device 120 is shared with other departments and software tools to create one centralized system that can handle accounting, inventory control, merchandising, and product forecasting. POS device 120 can provide function for the smallest retail business to the largest global conglomerate. In an embodiment, POS device 120 includes display 122.

According to embodiments of the present invention, display 122 is an electronic visual device for a desktop computer, laptop computer, tablet computer, smartphone, smartwatch, and the like. Display 122 may include a touchscreen which is an input device layered on top of the display for allowing a user to control an electronic device via simple or multi-touch gestures by touching display 122 with a special stylus and/or one or more fingers. Display 122 displays open programs and applications, allowing a user of POS device 120 to interact with the open programs and applications via a keyboard, mouse, and buttons (not shown in FIG. 1). Display 122 may be a thin film transistor liquid crystal display (TFT-LCD), a flat panel LED (light emitting diode) display, a cathode ray tube (CRT), or any type of display device known in the art or developed in the future. Display 122 may be connected to POS device 120 via VGA (video graphics array), DVI (digital video interface), HDMI (High Definition Multi-Media Interface or any other connection type known in the art.

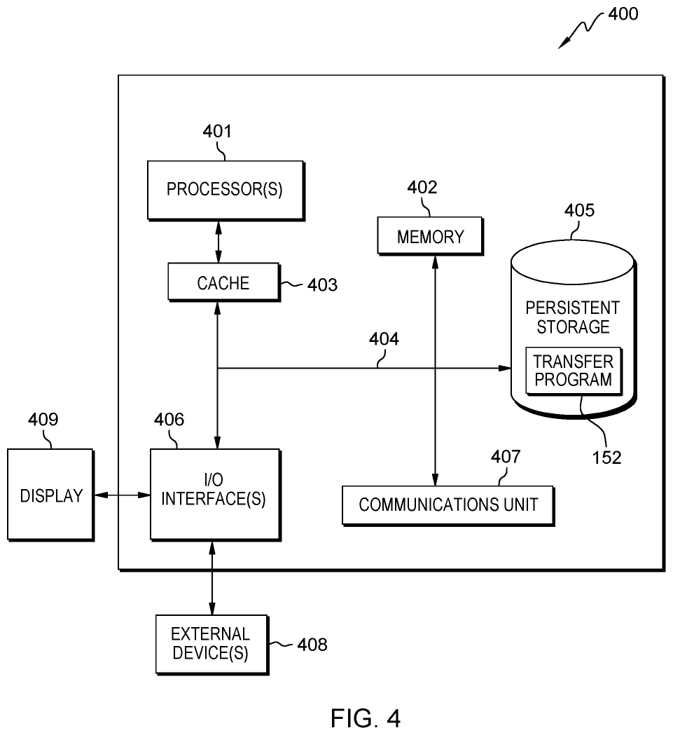

In an embodiment, transaction server 130 may be one of a laptop, tablet, or netbook personal computer (PC), a desktop computer, a personal digital assistant (PDA), a smartphone, a standard cell phone, a smartwatch or any other wearable technology, or any other hand-held, programmable electronic device capable of communicating with any other computing device within computing environment 100. According to embodiments, transaction server 130 can be a standalone computing device, a management server, a web server, a mobile computing device, or any other electronic device or computing system capable of receiving, transmitting, and processing data. In other embodiments, transaction server 130 can represent computing systems utilizing multiple computers as a server system, such as in a cloud computing environment. In certain embodiments, transaction server 130 represents a computer system utilizing clustered computers and components (e.g., database server computers, application server computers, etc.) that act as a single pool of seamless resources when accessed by elements of computing environment 100. In general, transaction server 130 is representative of any electronic device or combination of electronic devices capable of executing computer readable program instructions. In an embodiment, computing environment 100 includes any number of transaction server 130. Transaction server 130 may include internal and external hardware components as depicted and described in further detail with respect to FIG. 4, in accordance with embodiments of the present invention. In an embodiment, transaction server 130 carries out sales transactions for POS device 120 via communication over network 110.

According to an embodiment of the present invention, mobile device 140 is a computing device small enough to be held or worn and operated by hand. Mobile device 140 may have an LCD or OLED flat screen interface, providing a touchscreen interface with digital buttons and a keyboard or with physical buttons along with a physical keyboard. Examples of mobile device 140 include smartphones and smartwatches. In an embodiment, mobile device 140 can connect to the Internet and interconnect with other devices such as car entertainment systems or headsets via network 110 or near field communication (NFC). Capabilities of mobile device 140 include taking photographs via an integrated camera, the ability to place and receive voice and video telephone calls, playing video games, and map locating via Global Positioning System (GPS). In an embodiment, mobile device 140 is powered via a lithium battery. Mobile device 140 may run mobile operating systems that allow third-party apps specialized for said capabilities to be installed and run. In an embodiment, computing environment 100 includes any number of mobile device 140. Mobile device 140 may include internal and external hardware components as depicted and described in further detail with respect to FIG. 4, in accordance with embodiments of the present invention. In an embodiment, mobile device 140 includes display 142, user interface 144, and transfer application 146.

According to an embodiment of the present invention, display 142 is an electronic visual device for a desktop computer, laptop computer, tablet computer, smartphone, smartwatch, and the like. Display 142 may include a touchscreen which is an input device layered on top of the display for allowing a user to control an electronic device via simple or multi-touch gestures by touching display 142 with a special stylus and/or one or more fingers. Display 142 displays user interface 144 as well as open programs and applications, allowing a user of mobile device 140 to interact with the open programs and applications via a keyboard, mouse, buttons, and/or touchscreen (not shown in FIG. 1). Display 142 may be a thin film transistor liquid crystal display (TFT-LCD), a flat panel LED (light emitting diode) display, a cathode ray tube (CRT), or any type of display device known in the art or developed in the future. Display 142 may be connected to transaction mobile device 140 via VGA (video graphics array), DVI (digital video interface), HDMI (High Definition Multi-Media Interface or any other connection type known in the art.

In an embodiment, user interface 144 provides an interface between a user of mobile device 140 and transfer application 146. User interface 144 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. User interface 144 may also be mobile application software that provides an interface between mobile device 140 and transfer application 146. Mobile application software, or an “app,” is a computer program designed to run on smartphones, tablet computers and other mobile devices. User interface 144 enables a user of mobile device 140 to interact with transfer application 146, transaction server 130, POS device 120, transfer program 152, and any other computing devices not shown in FIG. 1.

According to one embodiment, transfer application 146 is a software program or group of programs designed for end users. Examples of other end user programs include a word processor, a spreadsheet, an accounting application, a web browser, an email client, a media player, a file viewer, an aeronautical flight simulator, a console game, and a photo editor. Transfer application 146 may be bundled with the mobile device 140 and its system software or published separately, and may be coded as proprietary, open-source, or a university project. Software applications, such as transfer application 146 that are built for mobile platforms are called mobile apps. In an embodiment, transfer application 146 utilizes the preferences of a user and displays a point-of-sales device, such as POS device 120, on the display of a computing device of a user, such as mobile device 140.

In an embodiment, server device 150 may be one of a laptop, tablet, or netbook personal computer (PC), a desktop computer, a personal digital assistant (PDA), a smartphone, a standard cell phone, a smartwatch or any other wearable technology, or any other hand-held, programmable electronic device capable of communicating with any other computing device within computing environment 100. According to embodiments, server device 150 can be a standalone computing device, a management server, a web server, a mobile computing device, or any other electronic device or computing system capable of receiving, transmitting, and processing data. In other embodiments, server device 150 can represent computing systems utilizing multiple computers as a server system, such as in a cloud computing environment. In certain embodiments, server device 150 represents a computer system utilizing clustered computers and components (e.g., database server computers, application server computers, etc.) that act as a single pool of seamless resources when accessed by elements of computing environment 100. In general, server device 150 is representative of any electronic device or combination of electronic devices capable of executing computer readable program instructions. In an embodiment, computing environment 100 includes any number of server device 150. Server device 150 may include internal and external hardware components as depicted and described in further detail with respect to FIG. 4, in accordance with embodiments of the present invention. In an embodiment, server device 150 includes transfer program 152.

According to an embodiment of the present invention, transfer program 152 can be a program, a subprogram of a larger program, an application, a plurality of applications, or mobile application software, which functions to provide for a transfer of a point-of-sale terminal to a computing device of a user and generating a remote POS terminal on said computing device. A program is a sequence of instructions written to perform a specific task. In an embodiment, transfer program 152 runs by itself. In other embodiments, transfer program 152 depends on system software (not shown in FIG. 1) to execute. In one embodiment, transfer program 152 functions as a stand-alone program residing on server device 150. In another embodiment, transfer program 152 works in conjunction with other programs, applications, etc., found in computing environment 100. In yet another embodiment, transfer program 152 resides on any computing device within computing environment 100. In yet another embodiment, transfer program 152 resides on other computing devices (not shown in FIG. 1) in computing environment 100, which are interconnected to server device 150 via network 110.

According to an embodiment, transfer program 152 receives language and format preferences of a user. In the embodiment, transfer program 152 determines that the user has initiated a purchase. Further in the embodiment, transfer program 152 transmits a prompt to the user and subsequently receives an indication from the user which indicates that the user wants to complete the purchase on a computing device of the user. Further yet in the embodiment, transfer program 152 retrieves the preferences of the user previously received. Further yet in the embodiment, responsive to retrieving the user preferences for language and format, transfer program 152 generates a user interface of a point-of-sale device on a computing device of the user so that the user is able to complete a sales transaction on the computing device of the user in the preferred language and format of the user.

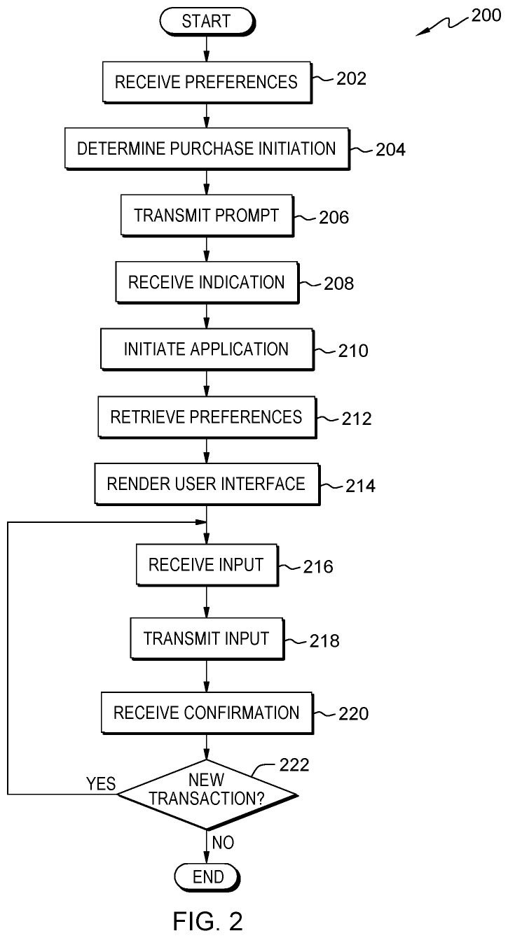

FIG. 2 is a flowchart of workflow 200 depicting a method for providing for a transfer of a point-of-sale terminal (POS) to a computing device of a user and generating a remote POS terminal on said computing device. In one embodiment, the method of workflow 200 is performed by transfer program 152. In an alternative embodiment, the method of workflow 200 is performed by any other program working with transfer program 152. In an embodiment, a user of mobile device 140 invokes workflow 200 upon initiating a sales transaction. In an alternative embodiment, a user of POS device 120 invokes workflow 200 upon a user initiating a sales transaction.

In an embodiment, transfer program 152 receives preferences (step 202). In other words, transfer program 152 receives the preferences of a user as part of the initial setup for transfer program 152. In an embodiment, types of user preferences include, but are not limited to, written language, spoken language, currency, accessibility options such as font size, magnification, text-to-speech, and color management, and store “rewards” numbers (i.e., an account with a store where the user earns loyalty points, or “rewards”, for purchasing items from the store). In the embodiment, transfer program 152 stores the received user preferences to a memory (not shown in FIG. 1) for use later by transfer program 152. According to an embodiment of the present invention, transfer program 152 receives the user preferences of a user of mobile device 140 via network 110. For example, Lea is a foreign exchange student from France who plans to attend college in the United States. Due to various circumstances, Lea is only beginning to learn the English language now and to do so, Lea is taking a preparatory English class. A program on a smartphone owned by Lea receives display preferences from Lea which include the preferences to read and listen in the French language, a currency preference of the Euro, and a coffee shop rewards number.

According to an embodiment of the present invention, transfer program 152 determines a purchase initiation (step 204). In other words, transfer program 152 determines that a user has initiated a purchase of one or more items using a point-of-sale (POS) terminal. In an embodiment, transfer program 152 determines a purchase initiation when a user swipes or inserts a credit card on the POS terminal. In another embodiment, transfer program 152 determines a purchase initiation when a user connects wirelessly to the POS terminal via a mobile device payment system. In yet another embodiment, transfer program 152 determines a purchase initiation when a user indicates, via an interaction with the POS terminal (e.g., pushing a button), that the user intends to pay for the purchase using cash. According to an embodiment of the present invention, transfer program 152 determines a purchase initiation from a credit card swipe at POS device 120 in computing environment 100. For example, the program on the smartphone Lea is using determines that Lea is about to make a coffee and cookie purchase at a POS kiosk in the coffee shop based on the mobile payment system on the smartphone connecting to the kiosk via near field communication.

In an embodiment, transfer program 152 transmits a prompt (step 206). In other words, responsive to determining the initiation of a purchase, transfer program 152 transmits a prompt to the user initiating said purchase. According to an embodiment, the prompt transmitted to the user is a question asking whether or not the user wants to complete the initiated purchase transaction on a computing device in the possession of the user. In one embodiment, the transmitted prompt is of a type that the user must read (e.g., a text message). In another embodiment, the transmitted prompt is of a type that the user must listen to (e.g., an audio message). In yet another embodiment, the transmitted message includes both text and audio types of messages. In the embodiment, the transmitted prompt can include one or more of an audio alert, a visual alert, and a haptic alert. According to an embodiment of the present invention, transfer program 152 transmits a prompt, via network 110, to mobile device 140 where the transmitted prompt is shown to the user of mobile device 140 on display 142 via user interface 144. For example, the program on the smartphone used by Lea transmits a prompt that Lea reads on the display of the smartphone.

In an embodiment, transfer program 152 receives an indication (step 208). In other words, transfer program 152 receives an indication, based on the transmitted response, of whether or not the user wants to complete the purchase on an available computing device. According to one embodiment, the received indication is an acknowledgement to complete the initiated purchase transaction on a computing device other than the POS terminal (i.e., a positive indication). According to another embodiment, the received indication is to use the POS terminal rather than another computing device (i.e., a negative indication). In an embodiment, transfer program 152 receives an indication from mobile device 140 via network 110 that the user prefers to complete the transaction using mobile device 140 rather than POS device 120. For example, the program on the smartphone receives an indication from Lea that Lea prefers to complete the purchase via the smartphone.

According to an embodiment of the present invention, transfer program 152 initiates an application (step 210). In other words, responsive to receiving a positive indication from the user, transfer program 152 initiates an application on the computing device of the user which will allow the user to complete the purchase via the computing device instead of the POS terminal. In an embodiment, the application is already available on the computing device. In another embodiment, the application is not available on the computing device but transfer program 152 has determined that the user has utilized the application for previous purchases; in the embodiment, transfer program 152 transmits the application to the computing device so the user is able to utilize the application for the current purchase. According to an embodiment, transfer program 152 initiates transfer application 146 on mobile device 140. For example, the program on the smartphone initiates an available application stored to the smartphone so that Lea is able to use the initiated application to complete the purchase.

According to an embodiment of the present invention, transfer program 152 retrieves preferences (step 212). In other words, responsive to initiating an application, transfer program 152 retrieves the stored preferences of the user. In an embodiment, the retrieved preferences are retrieved from a local memory on the computing device of the user. In another embodiment, the retrieved preferences are retrieved from a non-local memory on a computing device within computing environment 100. According to an embodiment, the retrieved preferences include, but are not limited to, written language, spoken language, currency, accessibility options such as font size, magnification, text-to-speech, and color management, and store “rewards” numbers (i.e., an account with a store where the user earns loyalty points, or “rewards”, for purchasing items from the store). In an embodiment, transfer program 152 retrieves the stored preferences of the user of mobile device 140 from a local storage (not shown in FIG. 1) on mobile device 140. For example, the program on the smartphone used by Lea retrieves, from a memory on the smartphone, the preferences of Lea that indicate the preferences of Lea to read and listen in the French language, to use the Euro as a preferred currency, and the rewards number of the coffee shop.

In an embodiment, transfer program 152 renders a user interface (step 214). In other words, responsive to retrieving the preferences of the user, transfer program 152 generates an application via the user interface on the computing device of the user which includes one or more screens and icons that when selected by the user perform one or more POS capabilities of the POS terminal. According to an embodiment, transfer program 152 renders a user interface in the preferences of the user which depicts POS device 120 on display 142 via user interface 144 on mobile device 140. For example, the program on the smartphone used by Lea depicts the user interface of the POS device of the coffee shop on the smartphone Lea is using to complete the purchase. The depiction of the POS device of the coffee shop is in the French language rather than the English language and currency is displayed in Euros rather than in American dollars.

According to an embodiment of the present invention, transfer program 152 receives input (step 216). In other words, transfer program 152 receives purchase input from the user via the rendered user interface which displays a depiction of the POS terminal. In an embodiment, the received input includes, but is not limited to, a confirmation of a purchase amount, a signature for the use of a credit card, an indication from the user of wanting a receipt, an indication of a type of receipt (e.g., printed hardcopy, e-mail softcopy, both), a request for a balance of a rewards account, and a request for cash back. According to an embodiment, transfer program 152 receives input over network 110 from the user of mobile device 140 via transfer application 146. For example, the program on the smartphone used by Lea receives input from Lea confirming the purchase of the coffee and cookie in the amount of five and a quarter Euros (equivalent to five dollars and sixty-nine cents), an indication from Lea for a printed receipt for the purchase, and a request for the account balance in the rewards program offered by the coffee shop.

In an embodiment, transfer program 152 transmits input (step 218). In other words, transfer program 152 transmits the received input from the user to the point-of-sale back end for processing of the purchase. According to an embodiment of the present invention, processing of the purchase includes, but is not limited to, confirming a valid payment method (e.g., credit card, mobile payment application, etc.), confirming a correct payment amount, validating the user (e.g., the signature of the user matches the owner of the credit card), providing for the type of receipt requested by the user, and providing rewards account information if requested. According to an embodiment, transfer program 152 on server device 150 transmits the input received from the user to transaction server 130 via network 110. For example, the program on the smartphone used by Lea transmits the input received from Lea to the coffee shop payment server for processing.

According to an embodiment of the present invention, transfer program 152 receives confirmation (step 220). In other words, responsive to transmitting the input received from the user, transfer program 152 receives confirmation of the payment as well as any other pertinent information. In an embodiment, the received confirmation includes, but is not limited to, confirmation that the payment of the user has been accepted and that the transaction has been completed, confirmation that a softcopy receipt was e-mailed to the user (if requested), and any requested rewards account information. According to another embodiment, transfer program 152 facilitates (i.e., completes) the transaction for the user. In the embodiment, when the transaction has been completed, transfer program 152 transmits the results of the completed transaction to the point-of-sale backend so that the transaction is closed. According to an embodiment, transfer program 152 receives confirmation from transaction server 130 via network 110 that the payment of the user was accepted and that the transaction was complete. For example, the program on the smartphone receives (i) confirmation that the payment made by Lea for five and a quarter Euros was accepted, (ii) instruction for the coffee shop POS terminal to print a receipt for the coffee and cookie, and (iii) a notation that the rewards account balance held by Lea was three and a half Euros which was just enough for a free large coffee.

In an embodiment, transfer program 152 determines whether a new transaction is underway (decision step 222). In other words, transfer program 152 determines whether the user is making another purchase and starting a new transaction. In an embodiment, reasons a user might start a new transaction include, but are not limited to, the user forgot to purchase something, the user is purchasing an item for someone else and needs a separate receipt, the user does not have a sufficient credit limit on a first credit card to cover the entire purchase requiring the user to use a second credit card for a portion of the purchase, and the user wants to use different credit cards for different items being purchased based on rewards program policies (e.g., a first credit card gives cash back for grocery purchases and a second credit card gives cash back for gasoline purchases). In one embodiment (decision step 222, YES branch), transfer program 152 determines that the user is making another purchase and is starting a new transaction; therefore, transfer program 152 proceeds to step 216 to receive input from the user. In the embodiment (decision step 222, NO branch), transfer program 152 determines that the user does not start a new transaction; therefore, transfer program 152 closes transfer application 146 and ends.

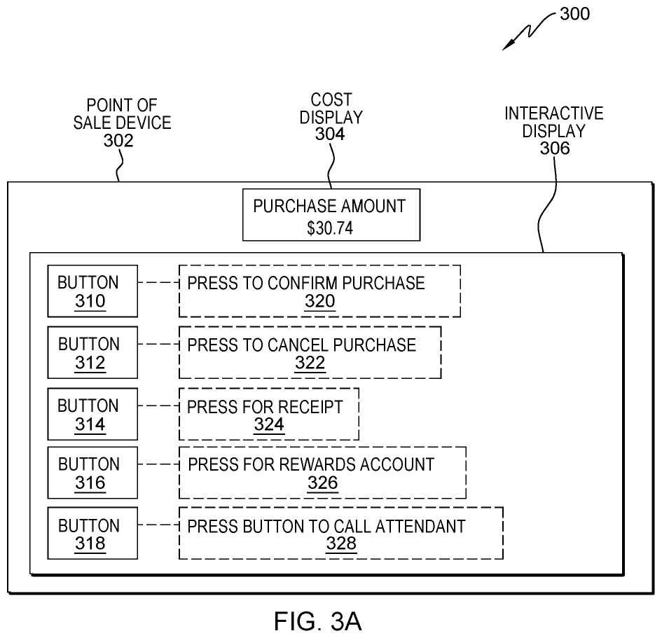

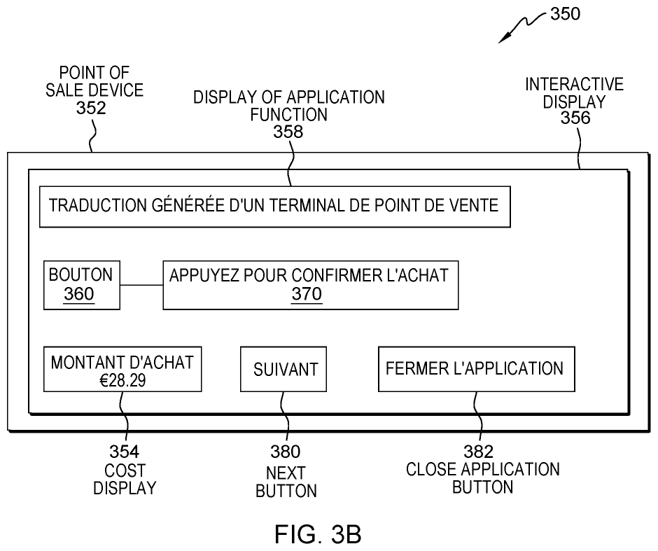

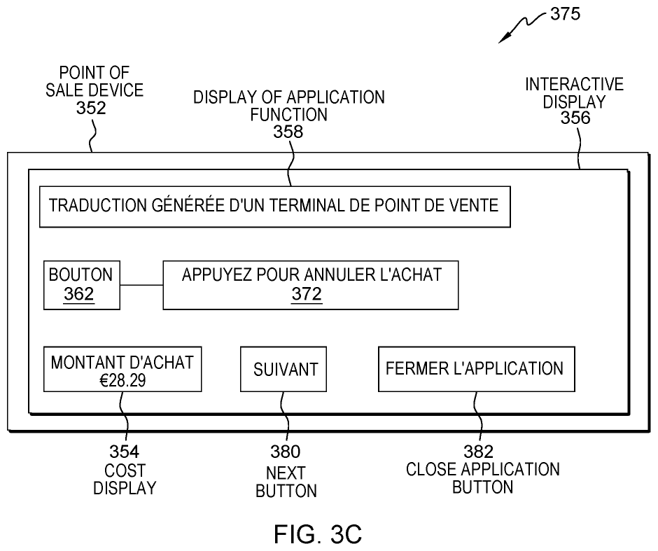

FIG. 3A is a depiction of a computing device used to make purchases with a credit card or payment application, generally designated 300, in accordance with an embodiment of the present invention. FIG. 3A provides only an illustration of one implementation and does not imply any limitations with regard to the systems and environments in which different embodiments may be implemented. Many modifications to the depicted embodiment may be made by those skilled in the art without departing from the scope of the invention as recited by the claims.

In an embodiment, FIG. 3A includes point-of-sale (POS) device 302. According to an embodiment of the present invention, POS device 302 is a device used for making one or more purchases using a credit card or a payment application included on a computing device, such as a smartphone, of a user. In an embodiment, POS device 302 is connected to a network such as network 110 (previously discussed in association with FIG. 1). In the embodiment, POS device 302 is substantially similar to point-of-sale device 120 in FIG. 1. According to an embodiment, POS device 302 includes cost display 304, interactive display 306, buttons 310 through 318, and messages 320 through 328 (which are associated with buttons 310 through 318, respectively).

According to an embodiment, cost display 304 is a device used to display the cost of the purchase to the user (i.e., the buyer in the transaction). In an embodiment, cost display 304 is substantially similar to display 142 on mobile device 140. In the embodiment, cost display 304 presents the cost in the prevailing currency for the location where cost display 304 is being used (e.g., in the United States (U.S.), U.S. dollars). In an example, cost display 304 displays a purchase cost of thirty dollars and seventy-four cents, U.S. (i.e., $30.74).

In an embodiment, interactive display 306 is an interactive device used to present virtual buttons and associated messages which are used during the purchase process. According to an embodiment of the present invention, interactive display 306 is a touchscreen. A touchscreen is both an input and an output device layered on the top of an electronic visual display of an information processing system. A user can give input or control the information processing system through simple or multi-touch gestures by touching the screen with a special stylus or one or more fingers. Some touchscreens use ordinary or specially coated gloves to work while others may only work using a special stylus or pen. The user can use the touchscreen to react to what is displayed and, if the software allows, to control how it is displayed; for example, zooming to increase the text size. The touchscreen enables the user to interact directly with what is displayed, rather than using a mouse, touchpad, or other such devices (other than a stylus, which is optional for most modern touchscreens).

According to an embodiment, interactive display 306 includes buttons 310-318 and associated messages 320-328. According to the embodiment, buttons 310-318 are virtual buttons displayed on interactive display 306. In an embodiment, the button/message pairs are: (i) button 310 and message 320 (“Press to Confirm Purchase”); (ii) button 312 and message 322 (“Press to Cancel Purchase”); (iii) button 314 and message 324 (“Press for Receipt”); (iv) button 316 and message 326 (“Press for Rewards Account”); and (v) button 318 and message 328 (“Press Button to Call Attendant”).

FIG. 3B, generally designated 350, is a depiction of a computing device used to make purchases with a credit card or payment application utilizing preferences of a user, in accordance with an embodiment of the present invention. FIG. 3B provides only an illustration of one implementation and does not imply any limitations with regard to the systems and environments in which different embodiments may be implemented. Many modifications to the depicted embodiment may be made by those skilled in the art without departing from the scope of the invention as recited by the claims.

In an embodiment, FIG. 3B includes point of sale (POS) device 352. In the embodiment, POS device 352 is similar to POS device 302. Further in the embodiment, POS device 352 is a device used for making one or more purchases using a credit card or a payment application included on a computing device, such as a smartphone, of a user. According to an embodiment of the present invention, POS device 352 is a generated new interface of POS device 302 that is generated by transfer program 152 utilizing the preferences of a user and the generated new interface is displayed via a user interface on a computing device of said user. In one embodiment, POS device 352 may be an exact translation (i.e., displays all of the content) of POS device 302 generated by transfer program 152. In another embodiment, POS device 352 may be an approximate translation (i.e., displays a portion of the content and can include new content) of POS device 302 generated by transfer program 152. In either embodiment, POS device 352 includes one or more screens and icons that when selected by the user perform one or more POS capabilities of POS device 302. For example, while POS device 302 includes five virtual buttons and associated messages, POS device 352 includes only one virtual button and an associated message. In the example, other differences between POS device 302 and POS device 352 include a different location for the cost display (e.g., cost display 354), a next button (e.g., next button 380), a close application button (e.g., close application button 382), and a display of application function (e.g., display of application function 358).

In an embodiment, display of application function 358 displays a name of an application in a portion of interactive display 356. In an example of the embodiment, display of application function 358 displays “TRADUCTION GÉNÉRÉE D'UN TERMINAL DE POINT DE VENTE” in French which when translated to English is “Generated Translation of a Point of Sale Terminal”. Note that there is not an equivalent of display of application function 358 on POS device 302 in FIG. 3A.

According to an embodiment, cost display 354, a portion of interactive display 356, displays the cost of the transaction in the currency preference of the user. In an example of the embodiment, cost display 354 displays “MONTANT D'ACHAT €28.29” in French which when translated to English is “Purchase Amount $30.74” (at the current exchange rate) as shown in cost display 304 in FIG. 3A.

In an embodiment, bouton 360, a portion of interactive display 356, is a virtual button for the user to utilize during the purchase process. In an example of the embodiment, bouton 360 displays “APPUYEZ POUR CONFIRMER L'ACHAT” (i.e., message 370) in French which when translated to English is “Press to Confirm Purchase” as shown in button 310/associated message 320 in FIG. 3A.

According to an embodiment, next button 380, a portion of interactive display 356, is a virtual button utilized by a user for advancing from a first displayed button/message pair to a next displayed button/message pair. According to an embodiment, the user can either (i) first hit virtual button ‘bouton 360’ to confirm the purchase and then hit next button 380 to see if a new bouton 362 is displayed in interactive display 356 or (ii) ignore bouton 360 and hit next button 380 to see if a new bouton 362 is displayed. In an embodiment, next button 380 is displayed in French as “SUIVANT” which when translated to English is “Close”. Note that there is not an equivalent of next button 380 on POS device 302 in FIG. 3A.

In an embodiment, close application button 382, a portion of interactive display 356, is a virtual button utilized by the user to close the application at the completion of the purchase. In an example of the embodiment, close application button 382 displays “FERMER L'APPLICATION” in French which when translated to English is “Close Application”. Note that there is not an equivalent of close application button 382 on POS device 302 in FIG. 3A.

FIG. 3C, generally designated 375, is a depiction of a computing device used to make purchases with a credit card or payment application utilizing preferences of a user, in accordance with an embodiment of the present invention. FIG. 3C provides only an illustration of one implementation and does not imply any limitations with regard to the systems and environments in which different embodiments may be implemented. Many modifications to the depicted embodiment may be made by those skilled in the art without departing from the scope of the invention as recited by the claims.

In an embodiment, FIG. 3C includes point of sale (POS) device 352. In the embodiment, in response to the user hitting next button 380, interactive display 356 displays the new information bouton 362 and associated message 372 which in French, shows “APPUYEZ POUR ANNULER L'ACHAT” (and translated to English reads “Press to Cancel Purchase”). Further in the embodiment, the remaining portions of POS device 352 in FIG. 3C are equivalent to POS device 352 in FIG. 3B. Further yet in the embodiment, when the user hits next button 380 again, a next button/message pair are displayed in interactive display 356 (e.g., bouton 364 and “PRESSE POUR RÉCEPTION 374”) and this continues until no new button/message pairs are available for display.

FIG. 4 depicts computer system 400, which is an example of a system that includes transfer program 152. Computer system 400 includes processors 401, cache 403, memory 402, persistent storage 405, communications unit 407, input/output (I/O) interface(s) 406 and communications fabric 404. Communications fabric 404 provides communications between cache 403, memory 402, persistent storage 405, communications unit 407, and input/output (I/O) interface(s) 406. Communications fabric 404 can be implemented with any architecture designed for passing data and/or control information between processors (such as microprocessors, communications and network processors, etc.), system memory, peripheral devices, and any other hardware components within a system. For example, communications fabric 404 can be implemented with one or more buses or a crossbar switch.

Memory 402 and persistent storage 405 are computer readable storage media. In this embodiment, memory 402 includes random access memory (RAM). In general, memory 402 can include any suitable volatile or non-volatile computer readable storage media. Cache 403 is a fast memory that enhances the performance of processors 401 by holding recently accessed data, and data near recently accessed data, from memory 402.

Program instructions and data used to practice embodiments of the present invention may be stored in persistent storage 405 and in memory 402 for execution by one or more of the respective processors 401 via cache 403. In an embodiment, persistent storage 405 includes a magnetic hard disk drive. Alternatively, or in addition to a magnetic hard disk drive, persistent storage 405 can include a solid-state hard drive, a semiconductor storage device, read-only memory (ROM), erasable programmable read-only memory (EPROM), flash memory, or any other computer readable storage media that is capable of storing program instructions or digital information.

The media used by persistent storage 405 may also be removable. For example, a removable hard drive may be used for persistent storage 405. Other examples include optical and magnetic disks, thumb drives, and smart cards that are inserted into a drive for transfer onto another computer readable storage medium that is also part of persistent storage 405.

Communications unit 407, in these examples, provides for communications with other data processing systems or devices. In these examples, communications unit 407 includes one or more network interface cards. Communications unit 407 may provide communications through the use of either or both physical and wireless communications links. Program instructions and data used to practice embodiments of the present invention may be downloaded to persistent storage 405 through communications unit 407.

I/O interface(s) 406 allows for input and output of data with other devices that may be connected to each computer system. For example, I/O interface 406 may provide a connection to external devices 408 such as a keyboard, keypad, a touch screen, and/or some other suitable input device. External devices 408 can also include portable computer readable storage media such as, for example, thumb drives, portable optical or magnetic disks, and memory cards. Software and data used to practice embodiments of the present invention can be stored on such portable computer readable storage media and can be loaded onto persistent storage 405 via I/O interface(s) 406. I/O interface(s) 406 also connect to display 409.

Display 409 provides a mechanism to display data to a user and may be, for example, a computer monitor.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

What is claimed is:

1. A method, the method comprising:
initiating, by one or more computer processors, an application on a computing device of a user which allows the user to complete a purchase via the computing device instead of an available point-of-sale (POS) terminal;
retrieving, by one or more computer processors, a set of preferences of the user;
generating, by one or more computer processors, a new interface of the available POS terminal for the user on the computing device based on the retrieved set of preferences of the user which includes one or more screens and icons that, when selected by the user performs one or more POS capabilities of the available POS terminal; and
rendering, by one or more computer processors, the generated new interface on the computing device of the user.

2. The method of claim 1, further comprising:
receiving, by one or more computer processors, the set of preferences from the user;
determining, by one or more computer processors, an initiation by the user of a purchase transaction at the POS terminal;
transmitting, by one or more computer processors, a prompt to the user; and
responsive to transmitting the prompt, receiving, by one or more computer processors, an indication from the user, wherein the indication from the user is an acknowledgement to complete the initiated purchase transaction on the computing device of the user.

3. The method of claim 1, further comprising:
receiving, by one or more computer processors, a first input from the user via the generated new interface of the available POS terminal; and
facilitating, by one or more computer processors, the purchase transaction of the user to completion.

4. The method of claim 3, wherein facilitating the purchase transaction of the user to completion is selected from the group consisting of transmitting the first input to a POS backend computing device for processing and transmitting the results of the completed purchase transaction to the POS backend after completing the purchase transaction on the generated new user interface of the POS terminal.

5. The method of claim 1, further comprising:
determining, by one or more computer processors, whether a new transaction has been started by the user; and
responsive to determining that a new transaction has been started by the user, receiving, by one or more computer processors, a new input from the user, via the generated new interface, associated with the new transaction.

6. The method of claim 1, wherein the generated new interface of the available POS terminal for the user on the computing device based on the retrieved set of preferences of the user is selected from the group consisting of an exact translation of the available POS terminal and an approximate translation of the available POS terminal.

7. The method of claim 2, wherein the initiation by the user of the purchase at the POS terminal is determined by one of a credit card swipe or insertion at the POS terminal and a connection of a mobile device payment system on the computing device of the user to the POS terminal.

8. A computer program product, the computer program product comprising:
one or more computer readable storage media; and
program instructions stored on the one or more computer readable storage media, the program instructions comprising:
program instructions to initiate an application on a computing device of a user which allows the user to complete a purchase via the computing device instead of an available point-of-sale (POS) terminal;
program instructions to retrieve a set of preferences of the user;
program instructions to generate a new interface of the available POS terminal for the user on the computing device based on the retrieved set of preferences of the user which includes one or more screens and icons that, when selected by the user, performs one or more POS capabilities of the available POS terminal; and
program instructions to render the generated new interface on the computing device of the user.

9. The computer program product of claim 8, further comprising program instructions stored on the one or more computer readable storage media, to:
receive the set of preferences from the user;
determine an initiation by the user of a purchase transaction at the POS terminal;
transmit a prompt to the user; and
responsive to transmitting the prompt, receive an indication from the user, wherein the indication from the user is an acknowledgement to complete the initiated purchase transaction on the computing device of the user.

10. The computer program product of claim 8, further comprising program instructions stored on the one or more computer readable storage media, to:
receive a first input from the user via the generated new interface of the available POS terminal; and
facilitate the purchase transaction of the user to completion.

11. The computer program product of claim 10, wherein facilitating the purchase transaction of the user to completion is selected from the group consisting of transmitting the first input to a POS backend computing device for processing and transmitting the results of the completed purchase transaction to the POS backend after completing the purchase transaction on the generated new user interface of the POS terminal.

12. The computer program product of claim 8, further comprising program instructions stored on the one or more computer readable storage media, to:
determine whether a new transaction has been started by the user; and
responsive to determining that a new transaction has been started by the user, receive a new input from the user, via the generated new interface, associated with the new transaction.

13. The computer program product of claim 8, wherein the generated new interface of the available POS terminal for the user on the computing device based on the retrieved set of preferences of the user is selected from the group consisting of an exact translation of the available POS terminal and an approximate translation of the available POS terminal.

14. The computer program product of claim 9, wherein the initiation by the user of the purchase at the POS terminal is determined by one of a credit card swipe or insertion at the POS terminal and a connection of a mobile device payment system on the computing device of the user to the POS terminal.

15. A computer system, the computer system comprising:
one or more computer processors;
one or more computer readable storage media; and
program instructions stored on the one or more computer readable storage media for execution by at least one of the one or more computer processors, the program instructions comprising:
program instructions to initiate an application on a computing device of a user which allows the user to complete a purchase via the computing device instead of an available point-of-sale (POS) terminal;
program instructions to retrieve a set of preferences of the user;
program instructions to generate a new interface of the available POS terminal for the user on the computing device based on the retrieved set of preferences of the user which includes one or more screens and icons that, when selected by the user, performs one or more POS capabilities of the available POS terminal; and
program instructions to render the generated new interface on the computing device of the user.

16. The computer system of claim 15, further comprising program instructions stored on the one or more computer readable storage media for execution by at least one of the one or more computer processors, to:
receive the set of preferences from the user;
determine an initiation by the user of a purchase transaction at the POS terminal;
transmit a prompt to the user; and
responsive to transmitting the prompt, receive an indication from the user, wherein the indication from the user is an acknowledgement to complete the initiated purchase transaction on the computing device of the user.

17. The computer system of claim 15, further comprising program instructions stored on the one or more computer readable storage media for execution by at least one of the one or more computer processors, to:
receive a first input from the user via the generated new interface of the available POS terminal; and
facilitate the purchase transaction of the user to completion.

18. The computer system of claim 17, wherein facilitating the purchase transaction of the user to completion is selected from the group consisting of transmitting the first input to a POS backend computing device for processing and transmitting the results of the completed purchase transaction to the POS backend after completing the purchase transaction on the generated new user interface of the POS terminal.

19. The computer system of claim 15, further comprising program instructions stored on the one or more computer readable storage media for execution by at least one of the one or more computer processors, to:
determine whether a new transaction has been started by the user; and
responsive to determining that a new transaction has been started by the user, receive a new input from the user, via the generated new interface, associated with the new transaction.

20. The computer system of claim 15, wherein the generated new interface of the available POS terminal for the user on the computing device based on the retrieved set of preferences of the user is selected from the group consisting of an exact translation of the available POS terminal and an approximate translation of the available POS terminal.
